(19) United States
(12) Patent Application Publication
(10) Pub. No.: US 2006/0126902 A1
(43) Pub. Date: Jun. 15, 2006

(54) Surface roughness measuring method and apparatus and turbine deterioration diagnostic method

(75) Inventors: Hisashi Matsuda, Tokyo (JP); Hiroshi Kawakami, Kanagawa-ken (JP); Asako Inomata, Kanagawa-ken (JP); Fumio Otomo, Kanagawa-ken (JP); Hiroyuki Kawagishi, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/285,017

(22) Filed: Nov. 23, 2005

(30) Foreign Application Priority Data
Dec. 10, 2004 (JP) 2004-358510

(51) Int. Cl. G06K 9/00

(52) U.S. Cl. 382/108

(57) ABSTRACT

A surface roughness measuring method including, measuring surface roughness and a surface color image information of a plurality of representative points of a surface of a first object to be measured, and preparing a calibration information indicating the relationship between color stimulus values for the surface color image information and the surface roughness. The surface roughness measuring method further includes taking a surface color image information of a plurality of measuring points of a surface of a second object to be measured, obtaining color stimulus values from the surface color image information of the measuring points, converting the color stimulus values of the measuring points to surface roughness of the measuring points using the calibration information, and displaying the surface roughness of the measuring points of the second object to be measured as a surface information.

### CROSS-REFERENCE TO RELATED APPLICATIONS

This application is based upon and claims the benefit of priority from the prior Japanese Patent Application No. 2004-358510, filed on Dec. 10, 2004; the entire contents of which are incorporated herein by reference.

### BACKGROUND OF THE INVENTION

1. Field of the Invention

The present invention relates to a surface roughness measuring method and apparatus and a turbine deterioration diagnostic method, and more particularly relates to a surface roughness measuring method and apparatus for measuring efficiently and accurately the surface roughness of various members including turbine blades and a turbine deterioration diagnostic method for accurately diagnosing a performance deterioration of the turbine based on the detected surface roughness.

2. Description of the Background

In a high-temperature fluid machine as well as a steam turbine and a gas turbine, members such as blades are thermally damaged due to exposure under the condition of high-temperature for a long period, so that a problem arises that the performance depending on the operation time is lowered. For example, in a case of steam turbine blades, generation of oxide scales proceeds on the blades due to operation with age, and the surface roughness of the blades is increased. The increase in the surface roughness of the blades is directly related to the reduction in the machine performance. Therefore, in order to retain the guarantee performance, it is necessary to periodically confirm the surface condition and surface roughness of the blades and exchange or repair them when necessary.

Although there are various surface roughness measuring methods available, a surface roughness measuring method using a detector of a feeler type is general. A surface roughness measuring instrument of a feeler type detects displacements of the vertical motion caused when a diamond feeler (pickup) having a small front end radius such as 10 μm or less traces uneven parts of the surface to be measured at a fixed speed. Namely, it traces the member surface by the pickup portion, thereby physically measures uneven parts of the member surface, that is, the surface roughness (refer to Non-Patent Document 1).

On the other hand, in Patent Document 1, a method for inspecting the erosion amount of steam turbine blades caused by erosion by a non-contact type optical roughness detector using a laser beam or ultrasonic waves is described. Further, in Patent Document 2, as an inspection method for a semiconductor film, a method for measuring reflected light from an object to be measured by a color CCD camera, measuring the surface roughness by the intensity of received light for each wave length region of RGB (Red, Green and Blue) and deciding acceptance or rejection of the semiconductor film is described.

[Non-Patent Document 1] Japanese Mechanical Society, Mechanical Engineering Manual, Chapter 10, 1987

[Patent Document 1] Japanese Patent Disclosure (Kokai) Hei 3-170043

[Patent Document 2] Japanese Patent Disclosure (Kokai) 2001-110861

In the surface roughness measuring instrument of the feeler type aforementioned, for accurate measurement, it is necessary to continuously press the pickup portion of the measuring instrument to the surface of a member to be measured by an appropriate force. Thus, it is necessary to execute measurement while retaining the measuring instrument by a special jig such as a magnet stand. Furthermore, during the measurement, the pickup portion traces the surface of the member to be measured while moving about 1 to 2 mm. Therefore, in a case that an object to be measured has many curved surfaces such as turbine blades, it is necessary to finely adjust the fixing of the jig so as to retain the pressing pressure within a fixed range in the measurement section. Furthermore, one measuring region, as described above, is a point representing the range from 1 mm to 2 mm, so that when inspecting the peripheral surface roughness distribution of the blades, it is necessary to measure repeatedly while changing the measuring position.

Further, the inspection method of the erosion amount of steam turbine blades caused by the erosion by a non-contact type optical roughness detector using a laser beam or ultrasonic waves described in Patent Document 1, the measurement range is a pin point. Therefore, to evaluate the surface roughness within a measurement range, as explained in Patent Document 1, a large-scale drive unit for accurately moving the detector is required. Thus, when applying this method to an object to be measured in which the measurement range is wide and curved like the turbine blade surfaces, this method is accompanied with many restrictions. Furthermore, in the method for irradiating a laser beam to an object to be measured, evaluating the reflected light by the intensity of received light in RGB, deciding uneven parts of the non-plane, and inspecting acceptance or rejection of a semiconductor film which is described in Patent Document 2, to decide fine uneven parts such as a semiconductor film, it is required to position the laser beam with high precision. Furthermore a drive unit for moving a laser beam generator with high precision is required. Accordingly, this method is not a technique which can be applied to an object to be measured having many curved surfaces and a large inspection area like turbine blades.

On the other hand, in recent years, an optical device such as a digital microscope has been developed, but it is still expensive. Moreover, the camera portion thereof is large, so that there is a disadvantage that a sufficient spatial allowance to install the camera portion around an object to be measured is necessary. Furthermore, the optical device is easily affected by vibration during measurement, thus measuring conditions are restricted. Therefore, for an object to be measured in which the surface roughness varies with the region like the blade surface, a surface roughness measuring technique for realizing easier measurement and a wider application range is desired, compared with the aforementioned methods.

### SUMMARY OF THE INVENTION

Accordingly, an object of the present invention is to provide a surface roughness measuring method and apparatus for measuring efficiently and accurately the surface roughness of a wide area of the surface of an object to be measured.

Another object of the present invention is to provide a turbine deterioration diagnostic method for accurately diagnosing a performance deterioration of a turbine.

According to an aspect of the present invention, there is provided a surface roughness measuring method including, measuring surface roughness and a surface color image information of a plurality of representative points of a surface of a first object to be measured, and preparing a calibration information indicating the relationship between color stimulus values for the surface color image information and the surface roughness. The surface roughness measuring method further includes taking a surface color image information of a plurality of measuring points of a surface of a second object to be measured, obtaining color stimulus values from the surface color image information of the measuring points, converting the color stimulus values of the measuring points to surface roughness of the measuring points using the calibration information, and displaying the surface roughness of the measuring points of the second object to be measured as a surface information.

According to an aspect of the present invention, there is provided a surface roughness measuring apparatus including a color image picking-up device configured to take a color image of a point of a surface of a first object to be measured and a second object to be measured, and a color stimulus value calculation device configured to calculate a color stimulus value of the point of the surface of the first object to be measured and the second object to be measured from the color image. The surface roughness measuring apparatus further includes a data base for holding a calibration information indicating the relationship between color stimulus values for the surface color and surface roughness of a plurality of representative points of the surface of the first object to be measured, and an image process display device configured to convert the color stimulus values of a plurality of measuring points of the surface of the second object to be measured to surface roughness based on the calibration information, and to display the surface roughness of the measuring points of the second object to be measured as a surface information.

According to still another aspect of the present invention, there is provided a turbine deterioration diagnostic method including, preparing an estimation information showing the relation between estimated turbine performance and operation time according to surface roughness of a turbine blade, and measuring a surface roughness of the second object to be measured according to the surface roughness measuring method as described above. Here, the second object being the turbine blade. The turbine deterioration diagnostic method further includes estimating the turbine performance based on the surface roughness of the turbine blade using the estimation information, and diagnosing turbine deterioration based on the estimated turbine performance.

The present invention can provide a surface roughness measuring method and apparatus for measuring efficiently and accurately the surface roughness of a wide area of the surface of an object to be measured.

Furthermore, the present invention can provide a turbine deterioration diagnostic method for accurately diagnosing a performance deterioration of a turbine.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing for explaining the principle of the present invention, in which (a) is a cross sectional view of a steam turbine blade and (b) shows the surface condition after a long term operation of the turbine viewed in a direction A1 shown in (a);

FIG. 2 is a block diagram showing a surface roughness measuring apparatus according to a first embodiment of the present invention;

FIG. 3 is a flow chart showing a surface roughness measuring method according to the first embodiment of the present invention;

FIG. 4 is a drawing for explaining a second embodiment of the present invention, in which (a) is a drawing showing a state that axes of coordinates are set on the surface of a turbine blade and (b) is a drawing showing a state that pixels are set in (a);

FIG. 5 is a drawing showing curves indicating the relationship between the color stimulus values and the surface roughness stored in a data base of a surface roughness measuring apparatus according to a second embodiment of the present invention;

FIG. 6 is a drawing showing curves indicating the relationship between the color stimulus values and the surface roughness plotted in an RGB space stored in a data base of a surface roughness measuring apparatus according to a third embodiment of the present invention;

FIG. 7 is a drawing for explaining an interpolation method for a color-surface roughness calibration curve stored in a data base of a surface roughness measuring apparatus according to a fourth embodiment of the present invention; and

FIG. 8 is a flow chart showing a turbine deterioration diagnostic method according to a fifth embodiment of the present invention.

### DETAILED DESCRIPTION OF THE INVENTION

Referring now to the drawings, wherein like reference numerals designate identical or corresponding parts throughout the several views, the embodiments of this invention will be described below.

On blades used in a steam turbine, oxide scales are generated on the blade surfaces due to long term operation of the steam turbine. Basically, the configuration of high-temperature oxidation depends on the atmospheric temperature and material used for blades. As the atmospheric temperature rises, the high-temperature oxidation proceeds. Further, it is known that the content of Cr in the material increases, the oxidation resistance is improved.

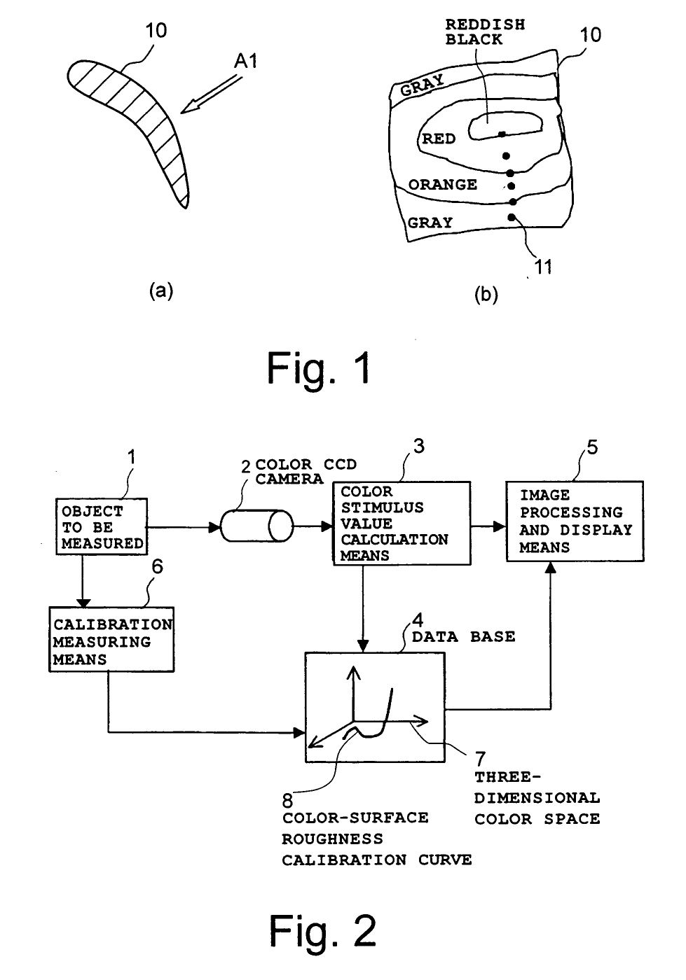

FIG. 1 is a drawing schematically showing the surface state of a stationary blade at the high-pressure stage of a steam turbine for power generation after long term operation thereof. In FIG. 1, (a) is a cross sectional view of a steam turbine blade, and (b) shows the surface condition after a long term operation of the turbine viewed in the direction A1. In FIG. 1, it shows that in a turbine blade 10 after the long term operation, according to the generation condition of oxide scales on the blade surface, the color of the surface thereof is changed from almost the gray which is the base color of the blade material to orange, red, furthermore reddish black. Further, the temperature condition and the material used for the blades vary with the turbine stage, so that such a pattern on the blade surface is characteristic at each stage. The part of the blade surface which is seen in the color from orange to red is an area where a rusted article containing a main component of iron dioxide is formed. The reddish black part of the blade surface is an area where a rusted article containing a main component of iron trioxide is formed.

To confirm the surface condition and surface roughness of the blade, the surface roughness is measured at several measuring points 11 on the blade surface of the turbine blade 10 shown in FIG. 1 using a detector of a feeler type. As a result, a strong correlation is recognized between the surface color and the surface roughness. It is found that the surface roughness is changed for each area different in the surface color, and as the oxidization of the member proceeds and the surface color is changed from gray to orange, red, and reddish black, the surface roughness is increased in association with it.

The present invention is developed on the basis of the aforementioned knowledge, and identifies the surface roughness of each member on the basis of a color image on the surface thereof.

### First Embodiment

FIG. 2 is a block diagram showing a surface roughness measuring apparatus according to a first embodiment of the present invention. This embodiment is composed of a color CCD camera 2 which is a color image picking-up means installed opposite to an object 1 to be measured such as a turbine blade, a color stimulus value calculation means 3, a data base 4, an image processing and display means 5, and a calibration measuring means 6.

As a color CCD camera 2, a digital still camera or a digital video camera for easily transferring data with the image processing and display means 5 such as a personal computer is used. The color CCD camera 2 is composed of many pixels and takes color image information of the surface of the object 1 to be measured such as a turbine blade. The color stimulus value calculation means 3 performs various image processing such as the noise processing and averaging processing for the color image information taken by the color CCD camera 2, and then it calculates color information for each spatial position of the surface of the object 1 to be measured, that is, color tristimulus values (for example, R, G, and B values).

The data base 4 preserves a color-surface roughness calibration curve 8, which is prepared on the basis of the surface roughness information separately measured by the calibration measuring means 6 such as a surface roughness measuring instrument of a feeler type at representative measuring points 11 of the object 1 to be measured different in the surface color and the color information at the concerned points 11 calculated by the color stimulus value calculation means 3. Specifically the color-surface roughness calibration curve 8 is prepared as described below. As the representative measuring points 11 shown in FIG. 1(b), for example, the surface roughness in the areas of the surface of the object 1 to be measured showing bright gray, gray, dark gray, orange, red, and reddish black are measured. Then, color tristimulus values (for example, R, G, and B colors) are calculated in the color stimulus value calculation means 3 by inputting the color image information at the measuring points 11 taken by the color CCD camera 2. Then, the relationship between the surface roughness and the color tristimulus values at the representative measuring points 11 are plotted in a three-dimensional color space 7. The color image information of the surface of the object 1 to be measured is affected and changed by the brightness and illumination at the time of taking. Therefore, in order to realize accurate measurement, it is necessary at each time of measurement to keep the distance between the color CCD camera 2 and the object 1 to be measured at the time of taking the color image information and the illumination environment at time of recording unchanged. Further, it is effective to use the tristimulus values of rgb system in which the effect of the brightness is removed, instead of the tristimulus values of RGB system.

The image processing and display means 5 inputs the color information (tristimulus values) obtained by the color stimulus value calculation means 3, refers to the data base 4, converts the color stimulus values to surface roughness for each spatial position of the overall surface of the object 1 to be measured based on the color-surface roughness calibration curve 8, and displays it as surface information.

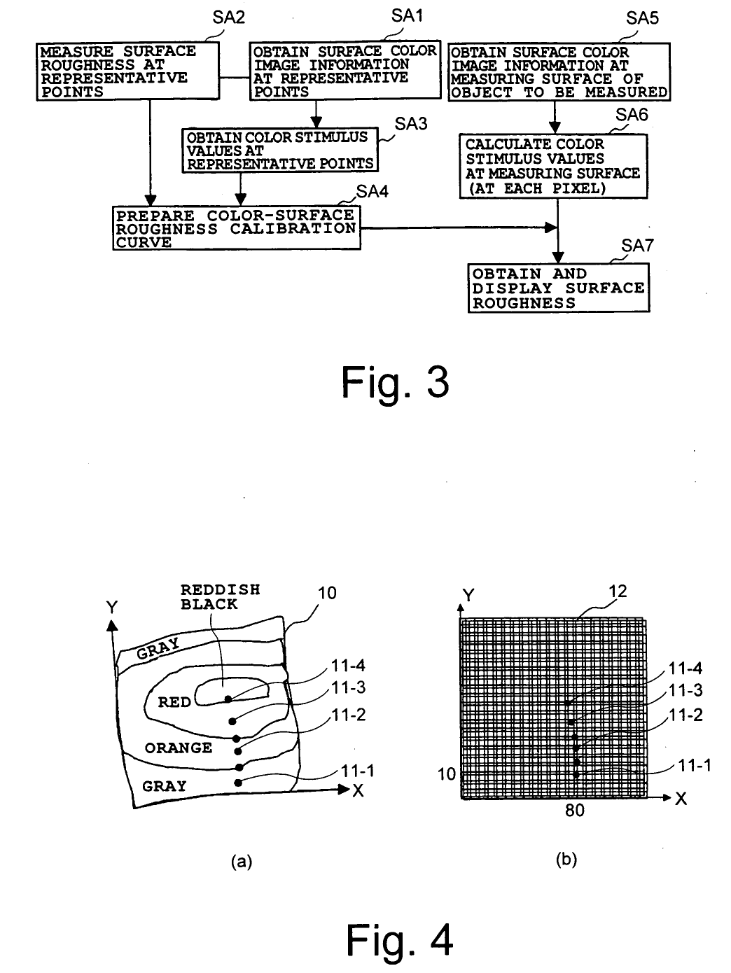

The surface roughness measuring procedure is as shown in FIG. 3. Firstly at a step SA1, a color image information at several representative points 11 of the object 1 to be measured different in color is obtained and recorded using the color CCD camera 2. Further, at a step SA2, at the representative points 11 of the object 1 to be measured, the surface roughness is measured by the calibration measuring means 6 such as of a feeler type. Next, at a step SA3, from the color image information obtained and recorded using the color CCD camera 2, color stimulus values at the representative points 11 are obtained by the color stimulus value calculation means 3. At a step SA4, the color-surface roughness calibration curve 8 (preserved in the data base 4) is prepared based on the color stimulus values and surface roughness at the representative points 11. Next, at a step SA5, the color CCD camera 2 takes the color image information of the overall measuring surface of the object 1 to be measured. At a step SA6, the color stimulus value calculation means 3 calculates color stimulus values of the overall measuring surface, and at a step SA7, the image processing and display means 5 inputs the color stimulus values, converts the color stimulus values of the overall measuring surface to surface roughness on the basis of the calibration curve 8 of the data base 4, and displays the roughness of the overall surface of the object 1 to be measured as a surface information.

According to this embodiment, the surface information of the surface roughness requiring enormous measuring points so far can be obtained easily and accurately. In the above-described embodiment, the detailed constructions of the color stimulus value calculation means 3 and the image processing and display means 5 are not described. But as it will be well-known to those skilled in the art to construct them based on the following document, the detailed description thereof may be omitted.

“A NEW THERMOCHROMIC LIQUID CRYSTAL TEMPERATURE IDENTIFICATION TECHNIQUE USING COLOR SPACE INTERPOLATIONS AND ITS APPLICATION TO FILM COOLING EFFECTIVENESS MEASUREMENTS” H. Matsuda et al., Journal of Flow Visualization & Image Processing, vol. 7, pp 103-121, 2000

### Second Embodiment

FIG. 4 is a drawing schematically showing the correspondence of pixels 12 to the representative measuring points 11, when the back of the turbine blade 10 shown in FIG. 1 is measured by the color CCD camera 2. In FIG. 4, (a) is a drawing showing a state that axes of coordinates are set on the surface of the turbine blade 10, and (b) is a drawing showing a state that pixels are set in (a). It is assumed that the back of the turbine blade 10 is measured at pixels of 100(X)×100(Y) and as one representative point 11 on the blade back, for example, the gray part 11-1 corresponds to the area at a pixel position of (X, Y)=(80, 10). The color information (for example, R, G, and B values) of the pixel area is picked up and recorded by the color CCD camera 2 and color stimulus value calculation means 3. When the area extends across a plurality of pixels, R, G, and B values are obtained for each pixel. Or, the area averaging processing may be performed. By the same method, color information (R, G, and B values) at several representative measuring points 11 is obtained. For example, the orange, red and reddish black parts 11-2, 11-3, 11-4 correspond to the areas at pixel positions of (X, Y)=(80, 14), (78, 18) and (76, 21), respectively. The data base 4 is made by corresponding the color information of the pixels 12 of the representative measuring points 11 (11-1, 11-2, 11-3, 11-4) obtained in this way to the surface roughness at the concerned points 11 (11-1, 11-2, 11-3, 11-4) obtained by the calibration measuring means 6.

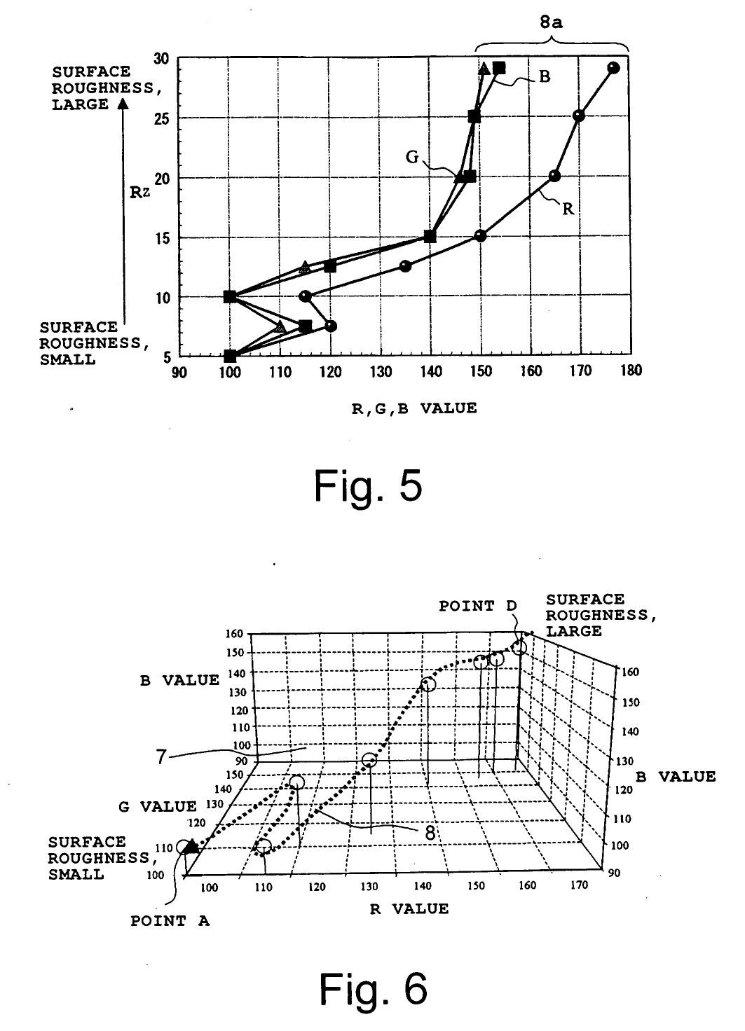

FIG. 5 shows a data base made by corresponding the color information (R, G, and B values) of the blade surface at several representative points 11 of the back of the turbine blade 10 obtained in this way to the information of surface roughness at the concerned points 11 obtained by the calibration measuring means 6 and properly arranging them. Here, in FIG. 5, R, G, and B values show color stimulus values converted in 8-bit (0-255) values, respectively, and the surface roughness shows maximum roughness Rz which is the maximum value in all the surface roughness values of the measured surface. The color information at the several representative points 11 of the object 1 to be measured and the surface roughness at the concerned points are obtained in this way, and thus the data base composed of the color-surface roughness calibration curve 8a can be obtained. In case of the data shown in FIG. 5, it is shown that the correlation between the R value and the surface roughness is strong particularly. It is found that, as the R values increases, the surface roughness increases almost uniquely. Within the range of small surface roughness, there is a part where two surface roughness values correspond to one R value. While within the range of larger surface roughness, when the R value is known as color information, the surface roughness can be identified. Further, when evaluated by the R value, two surface roughness values correspond to one R value within the range of small surface roughness. However, also in such a case, when these data are plotted in a three-dimensional color space (RGB space) 7 composed of axes of coordinates of the color tristimulus values, a data base described later in a third embodiment can be constructed. And the surface roughness can be identified uniquely using such the data base, the details of which will be described later.

Further, when the object 1 to be measured is a turbine blade, the condition that the turbine blade changes its surface color according to the generation of oxide scales and the surface roughness thereof is changed according to it is reproduced by simulating the actual operation conditions of a steam turbine by a high-temperature test equipment, or the information of the surface color and surface roughness measured separately is arranged properly, and thus a data base as shown in FIG. 5 can be constructed beforehand.

### Third Embodiment

The data base shown in FIG. 6 is that the R, G, and B values as color tristimulus values are used, and an RGB space as a three-dimensional space 7 composed of axes of coordinates of the stimulus values of R, G, and B is formed, and the R, G, and B values of the surface colors changing depending on the surface roughness of the object 1 to be measured are plotted in the space. Here, the mark ◯ show the data obtained by the interpolation with predetermined roughness intervals. In FIG. 5 showing the above-described second embodiment, the relationship between the R, G, and B values and the surface roughness is properly arranged two-dimensionally, while in FIG. 6, the exactly same data are properly re-arranged three-dimensionally. In FIG. 6, a point A indicates a condition of smallest surface roughness and a point D indicates a condition of largest surface roughness. Here, the points A and D in FIG. 6 correspond respectively the measuring points 11-1 and 11-4 in FIG. 4.

The surface roughness of the object 1 to be measured are measured at several representative points 11 different in the surface color from the area of smallest surface roughness indicated at the point A to the area of largest surface roughness indicated at the point D by the calibration measuring means 6. Further, the color information at the measuring points 11 is obtained using the color CCD camera 2 and color stimulus value calculation means 3. And, when the surface roughness are plotted in the RGB space, a color-surface roughness characteristic curve as a calibration line is obtained as shown in FIG. 6. When the surface roughness are plotted in the color space composed of axes of coordinates of the color tristimulus values (R, G, and B values in this case, but H, S, and L values of other tristimulus values may be used) like this, the relationship between the color and the surface roughness in the RGB space is indicated by one calibration curve 8, which does not cross (does not trace the same color), since the color information is different when surface roughness is different.

When the data base indicating the relationship between the color information and the surface roughness is constructed in the color space like this, even in the area of a multivalue function in which two surface roughness values correspond to one R value as shown in FIG. 5, the surface roughness of the object 1 to be measured can be identified uniquely by knowing the color information (the color tristimulus values) of the surface of the object 1 to be measured.

### Fourth Embodiment

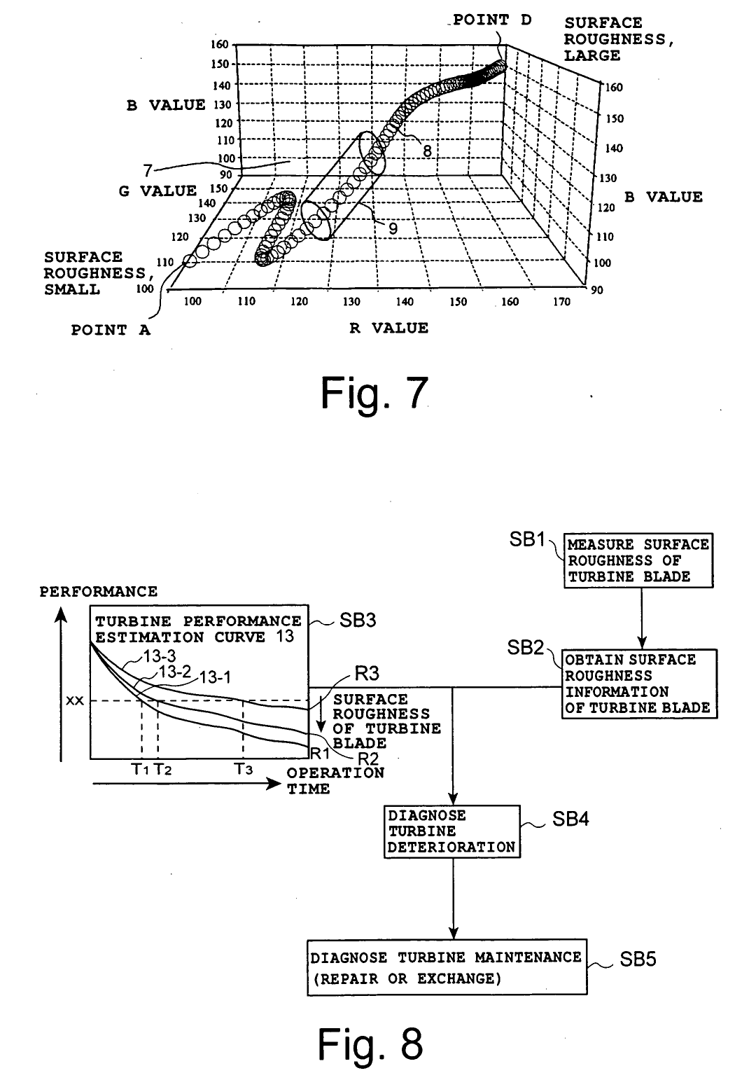

In the data base according to the third embodiment shown in FIG. 6, although each interval between the measuring points 11 indicated by the surface roughness and R, G, and B values is large. But this data interval is interpolated when necessary, and the surface roughness can be identified also for the surface color of the object 1 to be measured other than at the representative measuring points 11 where the surface roughness is directly measured. FIG. 7 shows a data base in which the data shown in FIG. 6 is interpolated according to changes in the surface roughness. In FIG. 7, the point A indicates a condition of smallest surface roughness and the point D indicates a condition of largest surface roughness.

Further, in the actual surface roughness measurement, even if the surface color of the object 1 to be measured is similar, the actual surface roughness may be varied often, so that all color informations do not always coincide with each other on the color-surface roughness calibration curve 8 obtained using the representative measuring points 11. Therefore, for such variation errors during measurement, the following process is performed to cope with them. Namely, the color-surface roughness calibration curve 8 is ideally a curve without the thickness. But in consideration of variations during measurement, a kind of tolerance is given to the allowable R, G, and B values for the surface roughness.

Namely, as shown in FIG. 7, a pipe-like tolerance area pipe 9 extending along the color-surface roughness calibration curve 8 is installed, and is adopted as a data base. Here, in FIG. 7, only a part of the pipe-like tolerance area pipe 9 is shown. And, when the R, G, and B values obtained by actually measuring the color information of the surface of the object 1 to be measured are included within the tolerance area pipe 9, the R, G, and B values are adopted as reliable data. And a point on the color-surface roughness calibration curve 8 at the shortest distance from the point in the three-dimensional color space 7 which is identified by the R, G, and B values is obtained, and the surface roughness corresponding to the point is adopted as a measured surface roughness value. Further, when the R, G, and B values obtained by actually measuring the color image information of the surface of the object 1 to be measured are not included within the tolerance area pipe 9, the R, G, and B values are judged as unreliable data for some reason and are not adopted. Such an information processing is performed in the image processing and display means 5.

In the first to fourth embodiments aforementioned, the surface roughness measurement of the steam turbine blades is explained. However, needless to say, in the present invention, the object 1 to be measured is not limited to the steam turbine blades. Further, in the processing the color image information, color stimulus values other than the R, G, and B values may be used. Further, depending on data, needless to say, instead of the development in the three-dimensional color space, the color-surface roughness calibration curve 8 of only the R value, only the G value or only the B value may be adopted.

### Fifth Embodiment

FIG. 8 is a flow chart showing an embodiment of the turbine deterioration diagnostic method of the present invention. In the steam turbine blades after the long term operation, according to the generation condition of oxide scales on the blade surface, the surface roughness of the blades is increased, and then the frictional loss of the blade periphery is increased. As a result, the pressure loss of the blade row is increased, and thus the performance of the steam turbine is deteriorated. With respect to the relation between the blade surface roughness and blade row performance, for example, a loss model as described in Boundary-Layer Theory, H. Schlichting, McGraw-Hill Book Company, pp. 611, (1968) is known. On the basis of this loss model, the deterioration of the turbine performance due to an increase in the blade surface roughness can be estimated.

Namely, as shown in FIG. 8, at a step SB1, the surface roughness of the turbine blades is measured by the surface roughness measuring method and apparatus described in the first to fourth embodiments. At a step SB2, surface roughness information is obtained. On the other hand, at a step SB3, a turbine performance estimation curve 13 is previously obtained, for example, based on the loss model as described above. In the turbine performance estimation curve 13, estimated values of turbine performance according to the blade surface roughness and operation times are shown. Here, it is found from the turbine performance estimation curve 13 that the estimated value of the turbine performance decreases with the increase of the operation time at a constant surface roughness of the turbine blades, and that the turbine performance decreases with the increase of the surface roughness of the turbine blade at the same operation time. Next, at a step SB4, the turbine deterioration diagnosis is made using the blade surface roughness information and the estimated value of turbine performance. And, at a step SB5, to retain the turbine efficiency higher than the guarantee performance, the maintenance diagnosis such as when to repair the blades or when to exchange the blades is made.

Here, it is assumed that when the turbine performance is reduced to a value XX the turbine is to be repaired. In a case that the surface roughness of a turbine blade is large (a case R1), it is to be repaired when the operation time reaches a time T1 based on a turbine performance estimation curve 13-1. Similarly, in a case that the surface roughness of a turbine blade is medium or small (a case R2 or a case R3) it is to be repaired when the operation time reaches a time T2 or a time T3 based on a turbine performance estimation curve 13-2 or 13-3.

According to this embodiment, the information of the turbine surface roughness over a wide range accurately measured can be used, so that the turbine performance deterioration diagnosis can be made more accurately, and timely and effective maintenance can be performed.

Obviously, numerous modifications and variations of the present invention are possible in light of the above teachings. It is therefore to be understood that within the scope of the appended claims, the invention may be practiced otherwise than as specifically described herein.

What is claimed is:

1. A surface roughness measuring method, comprising:
measuring surface roughness and a surface color image information of a plurality of representative points of a surface of a first object to be measured, and preparing a calibration information indicating the relationship between color stimulus values for said surface color image information and said surface roughness; and
taking a surface color image information of a plurality of measuring points of a surface of a second object to be measured, obtaining color stimulus values from said surface color image information of said measuring points, converting said color stimulus values of said measuring points to surface roughness of said measuring points using said calibration information, and displaying said surface roughness of said measuring points of said second object to be measured as a surface information.

2. The surface roughness measuring method according to claim 1, wherein:
said first object to be measured is identical to said second object to be measured.

3. The surface roughness measuring method according to claim 1, wherein:
the construction of said first object to be measured is the same as that of said first object to be measured; and
said calibration information indicating the relationship between color stimulus values for said surface color image information and said surface roughness is previously prepared.

4. The surface roughness measuring method according to claim 1, wherein:
said color stimulus values of said representative points of said first object to be measured and said color stimulus values of said measuring points of said surfaces of said second object to be measured are at least one of color tristimulus values.

5. The surface roughness measuring method according to claim 1, wherein:
said color stimulus values of said representative points of said first object to be measured and said color stimulus values of said measuring points of said surfaces of said second object to be measured are color tristimulus values; and
said calibration information indicating the relationship between said color tristimulus values for said surface color image information and said surface roughness is shown in a three-dimensional space composed of axes of coordinates of said tristimulus values.

6. The surface roughness measuring method according to claim 5, wherein:
said calibration information is indicated by a color-surface roughness calibration curve prepared by using interpolation method according to changes in said surface roughness.

7. The surface roughness measuring method according to claim 6, wherein:
a pipe-like tolerance area pipe is provided extending along said color-surface roughness calibration curve.

8. A surface roughness measuring apparatus, comprising:
a color image picking-up device configured to take a color image of a point of a surface of a first object to be measured and a second object to be measured;
a color stimulus value calculation device configured to calculate a color stimulus value of said point of said surface of said first object to be measured and said second object to be measured from said color image;
a data base for holding a calibration information indicating the relationship between color stimulus values for said surface color and surface roughness of a plurality of representative points of said surface of said first object to be measured; and
an image process display device configured to convert said color stimulus values of a plurality of measuring points of said surface of said second object to be measured to surface roughness based on said calibration information, and to display said surface roughness of said measuring points of said second object to be measured as a surface information.

9. The surface roughness measuring instrument according to claim 8, wherein:
said first object to be measured is identical to said second object to be measured and is a turbine blade.

10. The surface roughness measuring instrument according to claim 8, wherein:
said color stimulus values of said representative points of said first object to be measured and said color stimulus values of said measuring points of said surfaces of said second object to be measured are color tristimulus values; and
said calibration information indicating the relationship between said color tristimulus values for said surface color image information and said surface roughness is shown in a three-dimensional space composed of axes of coordinates of said tristimulus values.

11. A turbine deterioration diagnostic method, comprising:
preparing an estimation information showing the relation between estimated turbine performance and operation time according to surface roughness of a turbine blade.
measuring a surface roughness of said second object to be measured according to said surface roughness measuring method according to claim 1;
said second object being said turbine blade;
estimating said turbine performance based on said surface roughness of said turbine blade using said estimation information; and
diagnosing turbine deterioration based on said estimated turbine performance.
